(19) United States
(12) Patent Application Publication
(10) Pub. No.: US 2025/0347607 A1
(43) Pub. Date: Nov. 13, 2025

(54) QUANTIFYING MICROSTRUCTURAL FEATURES IN THERMAL SPRAY COATINGS USING IMAGE ANALYSIS TECHNIQUES

(71) Applicants: Rolls-Royce Corporation, Indianapolis, IN (US); Rolls-Royce North American Technologies, Inc., Indianapolis, IN (US)

(72) Inventors: Sidharth Krishnamoorthi, Indianapolis, IN (US); Matthew R. Gold, Indianapolis, IN (US); Robert Golden, Indianapolis, IN (US)

(21) Appl. No.: 18/661,009

(22) Filed: May 10, 2024

(51) Int. Cl. G01N 15/08; G06T 5/20; G06T 7/13; G06V 10/60; H04N 23/76

(52) U.S. Cl. CPC G01N 15/088; G06T 5/20; G06T 7/13; G06V 10/60; H04N 23/76

(57) ABSTRACT

A method includes receiving, by a computing device, a raw image indicative of a cross-section of a thermally-sprayed layer. The image includes a matrix of pixels, and each respective pixel in the matrix of pixels defines a luminance value. The method may further include determining, based on the luminance values, at least one pixel that corresponds to an oxide component in the layer and removing the at least one pixel that corresponds to the oxide component in the layer to generate a modified matrix of pixels. The method may further include generating an oxide-filtered image based on the modified matrix of pixels. The method may further include converting, by the computing device and based on the luminance values, the oxide-filtered image into a binary image and determining, by the computing device and based at least partially on the binary image, a porosity of the coating layer.

### TECHNICAL FIELD

The disclosure relates to thermal spray techniques, coating systems, and image analysis techniques.

### BACKGROUND

Thermal spray systems are used in a wide variety of industrial applications to coat targets with coating material to modify or improve the properties of the target surface. Coatings may include thermal barrier coatings, hard-wear coatings, environmental barrier coatings, or the like. Thermal spray systems use heat generated electrically, by plasma, or by combustion to heat material injected in a plume, so that molten material propelled by the plume contact the surface of the target. Upon impact, the molten material adheres to the target surface, resulting in a coating.

### SUMMARY

Thermal spray is a common application technique for metallic and/or ceramic coatings. In a thermal spray process, heat and fast-flowing gas accelerate a powder to at least partially melt and deposit the powder on a surface on the substrate. The melted powder impacts the substrate and flattens, resulting in layers of “splats” to build up the coating layer thickness. The microstructure of the thermally-sprayed coating consists of lamellae (e.g., flattened powders), closed pores (e.g., voids), splat lines which are the interface between individual lamellae, and oxide components which may form during manufacturing or operation or be included as part of the powder source.

It may be desirable to determine oxide content of the applied coating layer, the total porosity of the coating layer, the percentage of the total porosity that results from closed pores, and/or the percentage of the total porosity that results from splat lines. Determining these characteristics of the coating layer may allow for better understanding of the coating layer quality, potential failure modes, and/or selective tailoring of the thermal spray process to apply a coating layer that includes relatively more desirable characteristics.

Certain techniques for analyzing the porosity of a coating layer may include capturing and analyzing an image of a cross-section of the coating layer. The image may be compared by a skilled operator to an image of a desired coating layer to determine the total porosity or other characteristics. Other techniques may include converting the image to a binary image and summing the pixels in the binary image indicative of porosity to determine the coating porosity. Several problems may arise with these and other techniques. For example, oxide components may be captured in the image as relatively dark in color, similar to actual voids in the coating layer, and may thus be overcounted as part of the porosity of the coating. Additionally, or alternatively, it may be difficult or impossible to determine the percentages of the total porosity resulting from closed pores and resulting from splat lines. Thus, quality control and adaptive control of thermal spray processes may be relatively difficult when using such image analysis techniques.

According to one or more examples of the present disclosure, advanced image analysis techniques may be executed, which may allow for further understanding of characteristics and quality of the thermally-sprayed coating layer, and may further allow for selective tailoring of parameters of a thermal spray system (e.g., a thermal spray gun) in the same or in subsequent thermal spray processes. In techniques according to the present disclosure, an image processing technique may include receiving a raw image of a cross-section of a thermally-sprayed layer. The image may be normalized to correct for any sharp light gradients in the image which may be present from uneven illumination, generating a grayscale image. The technique may include applying an oxide filter, which may quantify the fraction of oxide components of the coating layer, and may optionally remove pixels corresponding to oxide components from a matrix of pixels making up the image, generating a modified matrix of pixels and thus an oxide-filtered image. A shape detection module may be executed to distinguish closed pores from splat lines, quantifying the percentage of the total porosity resulting from each type of porosity. The porosity due to the closed pores and the porosity due to splat lines may be added together to determine the total porosity. Accordingly, techniques according to the present disclosure may allow for accurate quantification of the oxide content, closed pore porosity, splat line porosity, and/or total porosity of the thermally-sprayed layer.

In one or more examples of the present disclosure, a technique includes receiving, by a computing device, a raw image indicative of a cross-section of a thermally-sprayed layer. The raw image includes a matrix of pixels, each pixel in the matrix of pixels defining a respective luminance value of a plurality of luminance values. The technique includes determining, by the computing device and based on the plurality of luminance values, at least one pixel of the matrix of pixels that corresponds to an oxide component in the layer. The technique further includes removing, by the computing device, the at least one pixel that corresponds to the oxide component in the layer from the matrix of pixels to generate a modified matrix of pixels, and generating, by the computing device and based on the modified matrix of pixels, an oxide-filtered image. The technique also includes converting, by the computing device and based on the luminance values of the oxide-filtered image, the oxide-filtered image into a binary image. The technique also includes determining, by the computing device, based at least partially on the binary image, a porosity of the thermally-sprayed layer.

In one or more examples of the present disclosure, a non-transitory computer-readable storage medium having stored thereon instructions that, when executed, configure a processor to receive a raw image indicative of a cross-section of a thermally-sprayed layer, wherein the raw image comprises a matrix of pixels, each pixel in the matrix of pixels defining a respective luminance value of a plurality of luminance values. The instructions further configure the processor to determine, based on the plurality of luminance values, at least one pixel of the matrix of pixels that corresponds to an oxide component in the layer. The instructions also configure the processor to remove the at least one pixel that corresponds to the oxide component in the layer from the matrix of pixels to generate a modified matrix of pixels. The instructions further configure the processor to generate, based on the modified matrix of pixels, an oxide-filtered image. The instructions further configure the processor to convert, based on the luminance values of the oxide-filtered image, the oxide-filtered image into a binary image. The instructions further configure the processor to determine, based at least partially on the binary image, a porosity of the thermally-sprayed layer.

In one or more examples of the present disclosure, a system includes a thermal spray gun configured to apply a thermally-sprayed layer to a substrate. The system further includes an imaging device configured to capture an image indicative of a cross-section of the thermally spraying layer, wherein the image comprises a matrix of pixels, each pixel in the matrix of pixels defining a luminance value. The system further includes a computing device. The computing device is configured to receive a raw image indicative of a cross-section of a thermally-sprayed layer, wherein the raw image comprises a matrix of pixels, each pixel in the matrix of pixels defining a respective luminance value of a plurality of luminance values. The computing device is configured to determine, based on the plurality of luminance values, at least one pixel of the matrix of pixels that corresponds to an oxide component in the layer. The computing device is further configured to remove the at least one pixel that corresponds to the oxide component in the layer from the matrix of pixels to generate a modified matrix of pixels, and generate by the computing device and based on the modified matrix of pixels, an oxide-filtered image. The computing device is further configured to convert by the computing device and based on the luminance values of the oxide-filtered image, the oxide-filtered image into a binary image. The computing device is configured to determine, based at least partially on the binary image, a porosity of the thermally-sprayed layer.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating a cross-section of a thermally-sprayed layer which include oxide components splat lines, and closed pores, according to one or more examples of the present disclosure.

FIG. 2 is a conceptual block diagram illustrating a thermal spray system including an imaging device and a computing device for analyzing a coating layer generated by a thermal spray system, according to one or more examples of the present disclosure.

FIG. 3 is a conceptual illustration of a computing device for analyzing an image representative of a thermally-sprayed layer, according to one or more examples of the present disclosure.

FIG. 4 is a flow diagram illustrating a technique for determining a porosity of a thermal-sprayed coating, according to one or more examples of the present disclosure.

FIGS. 5A-5E are conceptual and schematic diagrams illustrating images of a thermally-sprayed layer at various point in the method of FIG. 4.

FIGS. 6A-6D are conceptual diagrams illustrating an example oxide filtering technique, according to one or more examples of the present disclosure.

FIG. 7 is a conceptual diagram illustrating an example shape detection process for analyzing an image of a thermally-sprayed layer, according to one or more examples of the present disclosure.

FIG. 8 is a flowchart illustrating an example method for determining a porosity of a thermally-sprayed layer, according to one or more examples of the present disclosure.

### DETAILED DESCRIPTION

The disclosure describes systems and techniques for analyzing an image of a thermally-sprayed layer (“layer”) to determine one or more attributes of the layer. The layer may be a coating layer, which may be applied by a thermal spray system that includes a thermal spray gun. Thermally-sprayed layers of the present disclosure may include metallic and/or ceramic materials, and may be formed as thermal barrier coatings, hard-wear coatings, ablative coatings, or the like. Such coatings may have applications in the aerospace industry, such as on portions of gas turbine engines.

During a thermal spray process, the spray gun receives spray material (e.g., a powder or mixture of powders and/or binders and/or fugitive materials) and a carrier gas, at least partially melts the spray material, and directs the at least partially melted spray material toward a spray target using the carrier gas. The at least partially melted spray material contacts the spray target to provide a coating of the spray material on the spray target. In some examples, the quality of the coating on the spray target may depend on process attributes including, for instance, the spray material composition and flow rate; the carrier gas composition, temperature, and flow rate; the spray target composition and shape; the condition of the at least one component (e.g., the spray gun); and the like. Unsatisfactory coating characteristics may result from variances in process attributes, including process parameters, component wear, or both.

The melted spray material impacts the substrate and flattens, resulting in layers of “splats” to build up the coating layer thickness. The resulting microstructure of the thermally-sprayed coating may include one or more of lamellae (e.g., flattened powders), closed pores (e.g., voids), splat lines which are the interface between individual lamellae, and oxide components, which may form during manufacturing or operation or be included as part of the powder source.

It may be desirable to quantify the oxide content of the applied layer, the total porosity of the layer, the percentage of the total porosity that results from closed pores, and/or the percentage of the total porosity that results from splat lines. Determining these characteristics of the thermally-sprayed layer may allow for better understanding of the coating layer quality, potential failure modes, and/or selective tailoring of the thermal spray process to apply a layer that includes relatively more desirable characteristics. For example, a closed porosity (porosity associated with closed pores) may indicate the erosion resistance and/or abradability of the coating layer, while the splat line porosity may be indicative of the degree to which the coating layer is susceptible to delamination and spallation.

Certain techniques for analyzing the porosity of a layer may include capturing and analyzing an image of a cross-section of the layer. In such techniques, the image may be compared by a skilled operator to an image of a desired layer to determine the total porosity or other characteristics. However, such techniques may undesirably introduce variance between different operators, introducing human error to quantification of the porosity of the coating layer.

Other techniques may include converting the received raw image to a binary image and summing the pixels in the binary image indicative of porosity to determine the coating porosity. However, such techniques may not accurately describe the makeup of the layer. For example, oxide components may be captured in the image as relatively dark in color, similar to actual voids in the layer. During conversion into a binary image, these oxide components may be converted into pixels with a luminance value indicative of actual porosity in the layer, and may thus be overcounted as part of the porosity of the layer. Additionally, or alternatively, it may be difficult or impossible to determine the percentages of the total porosity resulting from closed pores and resulting from splat lines. Accordingly, quality control and/or adaptive control of thermal spray processes may be relatively difficult when using such image analysis techniques.

According to one or more examples of the present disclosure, advanced image analysis techniques may be executed by a computing device, which may allow for further analysis of characteristics and quality of the layer, and may further allow for selective tailoring of parameters of a thermal spray system (e.g., a thermal spray gun) in the same or in subsequent thermal spray processes. In techniques according to the present disclosure, an image processing technique may include receiving, by a computing device, a raw image of a cross-section of a layer. The raw image may be normalized to correct for any sharp light gradients in the image which may be present from uneven illumination, generating a grayscale image. The technique may include applying, by the computing device, an oxide filter, which may quantify the fraction of oxide components of the layer, and may optionally remove pixels corresponding to oxide components from a matrix of pixels making up the image. A shape detection module may be executed by the computing device to distinguish closed pores from splat lines, quantifying the percentage of the total porosity resulting from each type of porosity. The porosity due to the closed pores and the porosity due to splat lines may be added together to determine the total porosity. Accordingly, techniques according to the present disclosure may allow for accurate quantification of the oxide content, closed pore porosity, splat line porosity, and/or total porosity of the layer. The described techniques may be performed automatically by the computing device, which may improve the accuracy and/or speed with which the porosity of the layer may be determined.

In some examples, a technique includes receiving, by a computing device, a raw image indicative of a cross-section of a layer. The raw image may include a matrix of pixels, with each respective pixel in the matrix of pixels defining a luminance value. The technique may include determining, by the computing device and based on the luminance values, at least one pixel that corresponds to an oxide component in the layer. The technique may further include removing, by the computing device, the at least one pixel that corresponds to the oxide component in the layer from the matrix of pixels to form a modified matrix of pixels. The technique may also include generating an oxide-filtered image from the modified matrix of pixels. The technique may also include converting, by the computing device and based on the luminance values, the oxide-filtered image into a binary image. The technique may also include determining, by the computing device and based at least partially on the binary image, a porosity of the thermally-sprayed layer.

In some examples, the raw image indicative of a cross-section of the layer received by the computing device may include a matrix of individual pixels. The image may be a micrograph, and may be in black and white or in color. For example, the microstructure of a layer may be imaged with optical microscopy or electron microscopy (SEM). SEM images may generally not include colors other than black and white, and optical microscopy images may generally include colors other than black and white. The normalization step is primarily aimed at optical microscopy as lighting gradients and inhomogeneity are typically seen with optical micrographs. Each pixel in the matrix of pixels may define a luminance value. The luminance value may be the brightness intensity. In some examples, the brightness intensity may range from a luminance value of zero to indicate a black color to a luminance value of, for example, 255 to indicate a white color. Other scales of luminance values are also considered. Further, other examples are also considered, such as where the maximum luminance value is indicative of a black color and the minimum luminance value is indicative of a white color. In examples where the image is a color image, each pixel in the matrix of pixels may include a luminance value for each of a red color, a yellow color, and a blue color. The technique may include determining an overall luminance value by, for example, summing or averaging the luminance values for each of the red color, the yellow color, and the blue color. The technique may then proceed based on the determined overall luminance value.

In some examples, the image may be normalized to reduce or eliminate any brightness gradients that may result from the way the image is captured or other artificial means. For example, a camera flash may cause a central portion of the image to appear brighter than the perimeter of the image, and normalizing the image may correct for the camera flash. In some examples, normalizing the image may include adjusting, by the computing device, a luminance value of at least one pixel of the matrix of pixels. For example, adjusting the luminance value of at least one pixel may include determining a background luminance value for each individual pixel in the matrix of pixels, and subtracting the background luminance value from each individual pixel luminance value. The resulting normalized image may be called a grayscale image. Analysis of the grayscale image, with color removed and/or brightness gradients minimized, may result in a more accurate representation of the layer in the image relative to techniques which do not include a normalization step, because the grayscale image may correct for non-uniform illumination of the cross-section of the coating layer by reducing or eliminating brightness gradients. In some examples, the computing device may generate the grayscale image prior to determining the pixel(s) that correspond to the oxide component(s) in the layer. Thus, further analysis of the image may be performed on an image that is relatively free of noise introduced through non-uniform illumination.

As mentioned above, the computing device may determine, based on the luminance values, at least one pixel that corresponds to an oxide component in the layer. The computing device, based on this determination, may determine the oxide content of the layer. The oxide component or components may be generated by oxidization of the powder during the thermal spray process or may be introduced with the spray material. Quantification of the oxide content may allow for better understanding of material properties of the layer and/or adjustment of one or more parameters of the thermal spray system to modify the oxide content of the same or a subsequent layer. Furthermore, quantification of the oxide content may reduce or eliminate overestimation of the porosity of the layer by reducing or eliminating the counting of pixels which are indicative of oxide components as pixels which are indicative of voids.

On a visual review of a photograph or micrograph of the layer, pixels that correspond to void volumes (e.g., closed pores or splat lines) may have low luminance values, appearing black or nearly black. Similarly, pixels that correspond to oxide components may have relatively low luminance values, appearing dark gray or nearly black. Visual review, or a conversion of such an image into a binary image, may result in pixels that correspond to an oxide component being grouped with those pixels that correspond to void volumes. Thus, conventional analysis techniques may overestimate the porosity of a layer by counting pixels corresponding to oxide components as pixels that correspond to void volumes. Since performance of the layer may be directly correlated to the porosity of the layer, accurate measurement and control of the porosity may be important. Furthermore, since thermally-sprayed coatings may both introduce oxide components in the source powder and create oxide components during the thermal spray process, it may be especially important to distinguish between oxides and void volumes in a thermally-sprayed coating.

To determine the at least one pixel that corresponds to the oxide component or oxide components, the computing device may perform local thresholding. Local thresholding may distinguish between one or more pixels that correspond to oxide components and one or more pixels that correspond to void volumes, even in examples where both pixels that correspond to oxide components and pixels that correspond to void volumes have relative low luminance values. In some examples, the computing device may perform local thresholding by plotting each pixel of the plurality of pixels according to its luminance value. Local thresholding may include determining a local peak frequency of pixels with a particular luminance value occurring at a first luminance value. The computing device may determine a threshold matching range of luminance values surrounding the first luminance value, and may set the luminance value of pixels with a luminance value within the threshold matching range to the first luminance value. The computing device may determine that the plurality of pixels with the first luminance value correspond to the oxide component or oxide components in the layer.

In some examples, the local peak frequency is a first local peak frequency, and local thresholding may include determining that a second local peak frequency is indicative of void volumes within the coating layer and that a third local peak frequency is indicative of metal, ceramic, or alloy components within the layer. In this way, via local thresholding, the computing device may group one or more pixels that correspond to void volumes with other pixels that correspond to void volumes, one or more pixels that correspond to oxide components with other pixels that correspond to oxide components, and one or more pixels that correspond to metal, ceramic, or alloy components. The computing device may set a first luminance value for each pixel that corresponds to an oxide component, a second luminance value for each pixel that corresponds to a void volume, and a third luminance value for each pixel that corresponds to a metal, ceramic, or alloy component. By counting the number of pixels in each group, and by comparing each group to the total number of pixels, the computing device may determine and quantify a porosity, an oxide content, and metal, ceramic, or alloy fraction of the layer.

In some examples, the computing device may remove the one or more pixels that correspond to oxide components from the matrix of pixels that make up the raw image, forming a modified matrix of pixels. The modified matrix of pixels may include fewer pixels than matrix of pixels that make up the raw image. For example, the computing device may remove all pixels with the first luminance value from the matrix of pixels. By removing the pixels that correspond to oxide components, the computing device may generate an oxide-filtered image. The computing device may convert the oxide-filtered image into a binary image, and determine the porosity of the layer based on the binary image. In this way, the disclosed image processing techniques may prevent overcounting or undercounting the pixels that correspond to oxide components by applying an oxide filter.

As described herein, the computing device may convert an image (e.g., the raw image or the oxide-filtered image) into a binary image. In some examples, to convert an image into a binary image, the computing device may assign each pixel in the matrix of pixels making up to a luminance value that is equal to a luminance value of a black color or a luminance value that is equal to a white color. By way of example, if the scale of luminance values ranges from zero to 255, those pixels that have a luminance value from zero to 127 may be adjusted to have a luminance value of zero. Accordingly, those pixels that have a luminance value from 128 to 255 may be adjusted to have a luminance value of 255. In this way, an image may be converted into a binary image consisting of only pixels that are white or black. Techniques of the present disclosure may include converting the oxide-filtered image, the raw image, or both into a binary image.

The computing device may determine the total porosity of the layer by summing the fraction of the porosity that is present as closed pores and the fraction of the porosity that is present as splat lines. Determining the closed pore porosity and the splat line porosity separately from each other may be advantageous because these different types of porosity may impact the operational performance of the layer in different ways. For example, the fraction of the total porosity due to closed pores may correlate to the erosion resistance and/or abrasion resistance of the layer. The fraction of the total porosity due to splat lines may correlate to the susceptibility of the coating layer to delaminate. In some examples, the computing device may execute a shape detection module to determine a closed pore porosity and/or a splat line porosity.

The computing device may execute a shape detection module to determine the closed pore porosity. To execute the shape detection module, the computing device may determine that a shape a connected subplurality of pixels in the matrix of pixels all with a luminance value of zero is indicative of a closed pore. The computing device may identify at least one closed pore in the image by finding the shape within the matrix of pixels. The computing device may determine a boundary of the identified closed pore by grouping all pixels of the matrix of pixels that have a luminance value of zero and are part of a connected cluster of adjacent pixels that includes a pixel that is part of the shape as part of the at least one closed pore. The computing device may sum all pixels that are part of the at least one closed pore to determine the closed pore porosity. In some examples, the shape may be a cross, or a square, or a circle, or another shape. In examples, the shape may have dimensions of at least three pixels by at least three pixels. In some examples, the computing device may execute the shape detection module to determine a closed pore porosity on the oxide-filtered image after the oxide-filtered image is converted to a binary image.

The computing device may, alternatively or additionally to executing the shape detection module to determine the closed pore porosity, execute the shape detection module to determine the splat line porosity. In such examples, executing the shape detection module may include determining, by the computing device, that an uninterrupted chain of adjacent pixels in the matrix of pixels all with a luminance value of zero that meets a threshold length is indicative of a splat line. The computing device may identify at least one splat line in the image by finding the uninterrupted chain that meets the threshold length within the matrix of pixels. The computing device may determine an actual length of the identified splat line of the identified splat line by grouping all pixels of the matrix of pixels that have a luminance value of zero and are part of the uninterrupted chain of adjacent pixels as part of the at least one splat line. The computing device may sum all pixels that are part of the at least one splat line to determine the splat line porosity. In some examples, the computing device may execute the shape detection module to determine a splat line porosity on the raw image after the raw image is converted to a binary image. In some examples, identifying the at least one splat line may include determining that each pixel that is part of the at least one splat line is sandwiched between pixels that do not have a luminance value of zero. Shape detection modules disclosed herein may also advantageously allow for determination of the boundaries of individual closed pores and/or splat lines. Further, shape detection modules disclosed herein may allow for determination of the size distribution of closed pores and/or splat lines. Still further, shape detection modules disclosed herein may allow for determination of shapes of closed pores and/or splat lines in the image. Thus, shape detection modules disclosed herein may be rich in information that may be used to further understand and/or modify a thermal spray process.

In some examples, the computing device may perform the shape detection module in parallel branches. For example, the computing device may determine the closed pore porosity on the oxide-filtered image where the at least one pixel that corresponds to the oxide component in the layer has been removed. The computing device may determine the splat line porosity on the raw image where the one or more pixels that correspond to the oxide component have not been removed from the matrix of pixels. Put differently, an oxide filter may be applied prior to executing the shape detection module to identify closed pores in the received image, but the oxide filter may not be applied prior to executing the shape detection module to identify splat lines in the image. Oxide components may tend to form at splat lines, and applying an oxide filter before identifying splat lines in the image may lead to the omission of any splat lines that form with oxides in the splat line. At the same time, applying the oxide filter prior to determining the closed pore porosity may reduce or eliminate counting oxide components. Performing shape detection on both oxide-filtered image and the raw image may allow for more accurate determination of total porosity by more accurately measuring both closed pore porosity and splat line porosity.

In many cases, the computing device which performs the image analysis is a standalone computing device. The standalone computing device may perform the image analysis offline, that is, separately from the thermal spray system. Results of the image analysis may be used to make determinations about the quality of the layer and/or parameters of the thermal spray system which applied the layer. However, it is also considered that the computing device which performs the image analysis may be an integrated part of a thermal spray system which includes a thermal spray gun configured to apply a thermally-sprayed coating layer to a substrate and an imaging device. In such cases, the computing device may perform the image analysis and feedback results which may be used to control the thermal spray process. For example, the computing device may control (e.g., adjust) one or more parameters of the thermal spray gun based at least partially on the determined porosity. In some examples, the computing device may compare the determined porosity to a predetermined target range, and responsive to determining that the determined porosity does fall within the predetermined target porosity range, controlling, by the computing device, at least one parameter of the thermal spray gun.

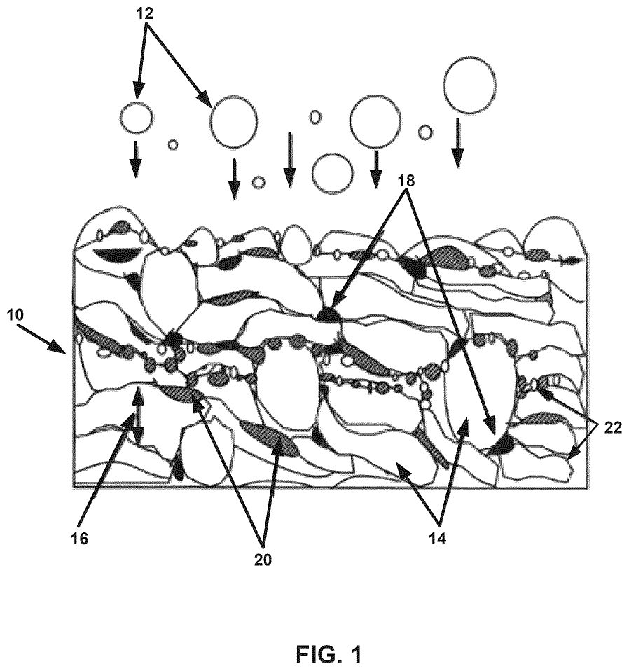

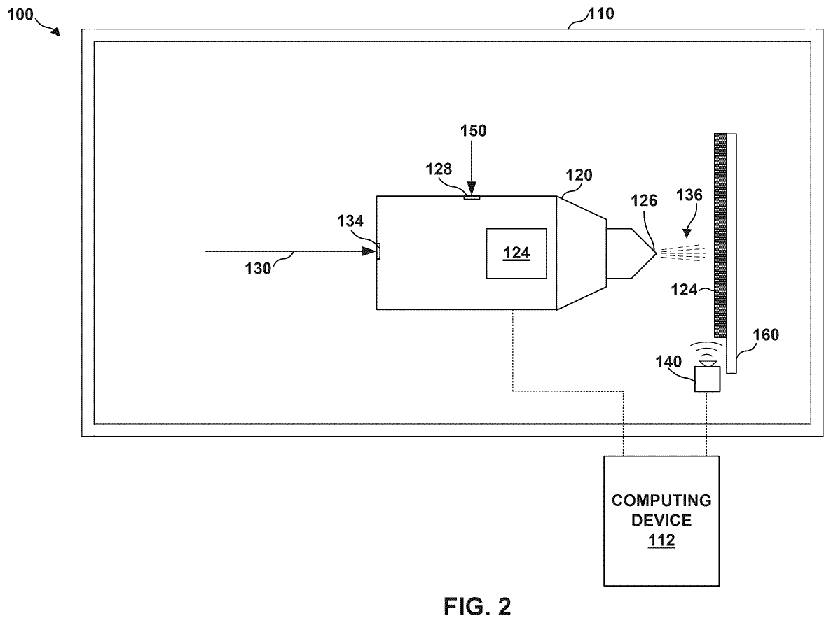

FIG. 1 is a conceptual diagram illustrating an example image indicative of a cross-section of a thermally-sprayed layer 10. Layer 10 is applied by a thermal spray system (for example, similar to thermal spray system 100 described with reference to FIG. 2). The thermal spray system may include an imaging device configured to capture the image of FIG. 1 and a computing device configured to analyze the image to determine a porosity of layer 10. Layer 10 may be a bond coat, a primer coat, a hard coat, a wear-resistant coating, a thermal barrier coating, an environmental barrier coating, an abradable coating layer or the like. As such, layer 10 may be a top or outer coating that is exposed to the environment, or may be an underlayer that is not exposed to the environment and has other coating layer formed on layer 10. Layer 10 may be formed as part of a high-temperature mechanical system such as a gas turbine engine. In some examples, layer 10 may be in a range of from about 10 micrometers to about 5,000 micrometers in thickness. As such, a cross-sectional image like the one conceptually illustrated in FIG. 1 may be taken under magnification by an imaging device of the thermal spray system.

The thermal spray system may direct a powder 12 with heat and carrier gases at a substrate to form layer 10. Powder 12 may at least partially melt during flight, and may flatten upon impact and adhere as lamellae 14. Lamellae 14 may have thickness 16, which may be a function of the powder particle size and distribution of powder 12, and the speed at which powder 12 is accelerated at the substrate. Layer 10 includes closed pores 18 and oxide components 20. Closed pores 18 are void volumes within layer 10. Oxide components 20 may be particles within layer 10 that contain oxygen. Oxide components 20 may be formed by oxidation of powder 12 during operation of system 10. Layer 10 defines splat lines 22, which may be defined at the interface between lamellae 14. Splat lines 22 may define relatively thin and small void volumes at the interface between lamellae 14.

Performance and material properties of layer 10 may depend on the relative fraction of lamellae 14, oxide components 20, close pores 18, and splat lines 22 present in layer 10, as well as other coating parameters. The total porosity (e.g., volume percentage of void space) of layer 10 may be a useful parameter, and may be considered the sum of the volume of closed pores 18 and splat lines 22 in layer 10. As such, it may be important to measure and quantify these parameters of layer 10. References to “porosity” herein may be assumed to mean “total porosity” unless otherwise specified. For example, “closed pore porosity” may be understood to mean the total void volume, expressed as a percentage of the volume of layer 10, of closed pores 18. Similarly, “splat line porosity” may be understood to mean the total void volume, expressed as a percentage of the volume of layer 10, of splat lines 22.

One way to measure the porosity of layer 10 is to analyze an image of a cross-section of layer 10 like the image of FIG. 1. The image of FIG. 1 is a two-dimensional image of a cross-section of layer 10. The image of FIG. 1 may be generated according to a sampling procedure. The sampling procedure may involve sampling layer 10, cutting into layer 10, and capturing an image representative of a cross-section of layer 10 with an imaging device. Sampling may occur on a temporal basis (e.g., every 1 minute of operation of system 10, every 5 minutes, or the like), or on an area basis of layer 10 (e.g., 1 square centimeter of layer 10 may be removed for imaging and analysis from every square meter of layer 10, or the like), or on a job basis (e.g., every third coated part is inspected by image processing techniques to determine a porosity of layer 10).

The computing device may analyze the two-dimensional image of FIG. 1 to determine a porosity of layer 10. The determined porosity may be the closed pore porosity, the splat line porosity, and/or the total porosity. For example, the received raw image may consist of a matrix of pixels. Each individual pixel in the matrix of pixels may define a luminance value. The computing device may determine, based on the luminance value, that one or more pixels in the matrix of pixels correspond to a void volume in the image. The computing device may determine that the sum of pixels that correspond to void volumes also correspond to the porosity of layer 10.

By way of example, the received raw image may be 1024 pixels by 1024 pixels, and thus the raw image may comprise 1,048,576 pixels. The computing device may determine that 104,858 pixels correspond to void volumes. Since 104,858 pixels correspond to voids out of a total of 1,048,576 pixels in the image, the computing device may determine that 10 percent of the pixels in the image correspond to void volumes. In some examples, the computing device may determine that the pixels indicative of void volumes in the image directly correlate to the porosity in layer 10. Thus, the computing device may determine that layer 10 has a porosity of 10 volume percent. Of course, other image matrix sizes and other determined porosities are also considered.

In some examples, the image of FIG. 1 may be analyzed to determine a porosity of layer 10. For example, a skilled operator may compare the image to an image of known porosity to determine porosity of layer 10. In other examples, the computing device may convert the raw image directly into a binary image. In a binary image, each pixel in the matrix of pixels may have a luminance value that corresponds to either a black color or a white color. However, as can be seen in FIG. 1, oxide components 20 may appear dark in color, similar to closed pores 18. In these examples, the skilled operator or the computing device may count oxide components 20 as closed pores 19. Accordingly, in these examples, the porosity of layer 10 may be overcounted and/or inaccurately measured. Furthermore, in these examples, the fraction of the total porosity present as closed pores 18 may not be distinguished from the fraction of the porosity present as splat lines 22. An example technique that includes comparison by a skilled operator is outlined in ASTM E2109-01.

In one or more examples of the present disclosure, the computing device may more accurately measure and quantify the presence of closed pores 18, oxide components 20, and splat lines 22 in layer 10 than techniques which rely on a skilled operator or a blunt conversion of an image of a cross-section of layer 10 into a binary image. In some examples, the disclosed techniques may employ an oxide filter to identify, quantify, and/or remove pixels that correspond to oxide components 20. The oxide filtering technique may employ local thresholding to distinguish between a peak frequency of luminance values that correspond to closed pores 18, a peak frequency of luminance values that correspond to oxide components 20, and a peak frequency of luminance values that correspond to the metal, ceramic, or alloy components in lamellae 14. The oxide-filtering technique may generate a modified matrix of pixels with pixels corresponding to oxide components removed. The computing device may generate an oxide-filtered image based on the modified matrix of pixels. In some examples, the porosity of layer 10 may be determined based on the oxide-filtered image.

In some examples, the disclosed techniques may include executing a shape detection module to distinguish between pixels that correspond to closed pores 18 and pixels that correspond to splat lines 22. The computing device may sum the pixels that are part of closed pores 18 to determine a closed pore porosity. Similarly, the computing device may sum the pixels that are part of splat lines 22 to determine a splat line porosity. As such, the described techniques may provide more information in a more accurate manner than conventional techniques. The output of the image analysis may be used to control the thermal spray system (e.g., a thermal spray gun) to adaptively control the thermal spray process in the same or a subsequent thermal spray operation. For example, the computing device may control one or more parameters of the thermal spray gun based on the porosity determined by image processing.

In some more advanced examples, the described techniques may employ a branched process to account for the fact that some relatively small oxide components 20 tend to form at splat lines 22, as shown in FIG. 1. In these examples, the computing device may normalize the received raw image to generate a grayscale image, then split the received image of FIG. 1 into two copies of the grayscale image. The computing device may apply the oxide filter to the first copy of the grayscale image to generate oxide-filtered version of the grayscale image, and may not apply the oxide filter to the second copy of the grayscale image. The computing device may perform oxide filtering remove one or more pixels corresponding to oxide components 20 in the oxide-filtered image. The computing device may convert the oxide-filtered image into a binary image, and then perform shape detection on the resulting oxide-filtered binary image to determine the closed pore porosity.

The computing device may not perform oxide filtering on the second copy of the grayscale image. Rather, the computing device may directly convert the grayscale image into a binary image. The computing device may then perform shape detection to determine the splat line porosity on the binary image. In examples which employ a branched process that include oxide-filtering a first copy of the grayscale image and not oxide-filtering a second copy of the grayscale image, the total porosity may be more accurately measured by not over including pixels corresponding to oxide components 20 and counting the pixels as closed pores 18 while also not removing pixels corresponding to splat lines 22 that include small quantities of oxide components 20. As such, a branched process that employs oxide filtering before determining the closed pore porosity of layer 10 and does not employ oxide filtering before determining the splat line porosity of layer 10 may be more accurate than other techniques.

FIG. 2 is a conceptual block diagram illustrating an example thermal spray system 100. In some examples, thermal spray system 100 includes components such as an enclosure 110, a thermal spray gun 120, imaging device 140, and a computing device 112. System 100 of FIG. 2 may be an example of the thermal spray system used to form layer 10 of FIG. 1, and thus may be capable of capturing the cross-sectional image of FIG. 1.

Enclosure 110 encloses some components of thermal spray system 100, including, for example, thermal spray gun 120 and imaging device 140. In some examples, enclosure 110 substantially completely surrounds thermal spray gun 120 and imaging device 140 and encloses an atmosphere. The atmosphere may include, for example, air, an inert atmosphere, a vacuum, or the like. In some examples, the atmosphere may be selected based on the type (e.g., composition) of coating being applied using thermal spray system 100. Enclosure 110 also encloses a spray target 160, to which coating layer 124 is applied.

Spray target 160 includes a substrate to be coated with coating layer 124 using thermal spray system 100. In some examples, spray target 160 may include a component used in any one or more mechanical systems, including, for example, a high temperature mechanical system such as a gas turbine engine. In such examples, coating layer 124 may be a bond coat, a primer coat, a hard coat, a wear-resistant coating, a thermal barrier coating, an environmental barrier coating, or the like. Coating layer 124 may be all or part of a coating system. Spray target 160 may include a substrate or body of any regular or irregular shape, geometry or configuration. In some examples, spray target 160 may include metal, plastic, glass, or the like.

Thermal spray gun 120 is coupled to a gas feed line 130 via gas inlet port 134, is coupled to a spray material feed line 150 via material inlet port 128, and includes or is coupled to an energy source 124. Gas feed line 130 provides a gas flow to gas inlet port 134 of thermal spray gun 120. Depending upon the type of thermal spray process being performed, the gas flow may be a carrier gas for the coating material, may be a fuel that is ignited to at least partially melt the coating material, or both. Gas feed line 130 may be coupled to a gas source (not shown) that is external to enclosure 110.

Thermal spray gun 120 also includes a material inlet port 128, which is coupled to spray material feed line 150. Material feed line 150 may be coupled to a material source (not shown) that is located external to enclosure 110. Coating material may be fed through material feed line 150 in powder form, and may mix with gas from gas feed line 130 within thermal spray gun 120. The composition of the coating material may be based upon the composition of the coating to be deposited on spray target 160, and may include, for example, a metal, an alloy, a ceramic, combinations thereof, or the like. The composition of coating material may include additives configure to impart properties to coating layer 124. Such additives may include fugitive materials intended to volatilize to impart porosity to coating layer 124.

Thermal spray gun 120 also includes energy source 124. Energy source 124 provides energy to at least partially melt the coating material from coating material provided through material inlet port 128. In some examples, energy source 124 includes a plasma electrode, which may energize gas provided through gas feed line 130 to form a plasma. In other examples, energy source 124 includes an electrode that ignites gas provided through gas feed line 130.

As shown in FIG. 2, an exit flowstream 136 exits outlet 126 of thermal spray gun 120. In some examples, outlet 126 includes a spray gun nozzle. Exit flowstream 136 may include at least partially melted coating material carried by a carrier gas. Outlet 126 may be configured and positioned to direct the at least partially melted coating material at spray target 160.

Thermal spray system 100 includes at least one imaging device 140. Imaging device 140 is configured to capture image data representative of a cross-section of coating layer 124. The imaging device may include optical equipment (lenses, mirrors, or the like) configured to capture the image as a micrograph. The imaging device may further include illumination equipment configured to illuminate coating layer 124 to capture the image data at a plurality of different luminance values. Imaging device 140 may be configured to capture, store, and/or transmit the image data as an image comprising a matrix of pixels. Each pixel in the matrix of pixels may define at least one luminance value. The luminance value may be indicative of the image intensity or brightness.

In some examples, the image may be a black and white image. In such examples, each pixel in the matrix of pixels may define a single luminance value. In some cases, the luminance value may be in a range from 0 to 255, where 0 corresponds to a black color, 255 corresponds to a white color, and the intervening numbers correspond to shades of gray between black and white.

Additionally, or alternatively, imaging device 140 may capture the image as a color image. In some color images, each pixel in the matrix of pixels may define a luminance value for each of a red color, a blue color, and a yellow color. The luminance values for each of red, green, and yellow may be scaled similarly to those described above. Alternative or additional color matrices are also considered.

Computing device 112 may be configured to control operation of one or more components of thermal spray system 100 automatically or under control of a user. For example, computing device 112 may be configured to control operation of thermal spray gun 120, gas feed line 130 (and the source of gas-to-gas feed line 130), material feed line 150 (and the source of material to material feed line 150), at least one imaging device 140, and the like. Computing device 112 also may be configured to receive at least one image of a cross-section of coating layer 124 (e.g., similar to as shown in FIG. 1) from at least one imaging device 140 and analyze and/or process the at least one image to determine a porosity and/or other characteristics of coating layer 124. The determined porosity and/or other characteristics of coating layer 124 may be used to determine and/or control one or more process attributes of thermal spray system 100.

During a thermal spray process, thermal spray system 100 performs at least one process, such as depositing coating layer 124 on spray target 160. Thermal spray system 100 and the thermal spray process performed by thermal spray system 100 possess a plurality of process attributes. In some examples, computing device 112 may store a desired target porosity for coating layer 124. The desired target porosity may be within a predetermined target porosity range (e.g., a bounded range, such as from 8 volume percent to 12 volume percent.

Computing device 112 may determine the porosity of coating layer 124 based on the luminance values of pixels in the matrix of pixels in the image captured by imaging device 140 and transmitted to computing device 112. Computing device 112 may compare the determined porosity to predetermined target range. Responsive to determining that the determined porosity does not fall within the predetermined target porosity range, computing device 112 may execute one or more actions. For example, computing device 112 may add a tag to the image which is indicative of the need for further inspection of coating layer 124 represented in the image. Further inspection may result in rework or discarding of spray target 160. Alternatively, or additionally to tagging the image, computing device 112 may stop deposition of coating layer 124 for inspection of system 100. In some examples, responsive to determining that the porosity of coating layer 124 does not fall within the predetermined target range for porosity, computing device 112 may control at least one parameter of thermal spray gun 120.

Parameters of thermal spray gun 120 may include process parameters such as at least one of a temperature, a pressure, a mass flow rate, a volumetric flow rate, a molecular flow rate, a molar flow rate, a composition or a concentration, of a flowstream flowing through thermal spray system 100, for instance, of gas flowing through gas feed line 130, or of exit flowstream 136, or of material flowing through material feed line 150.

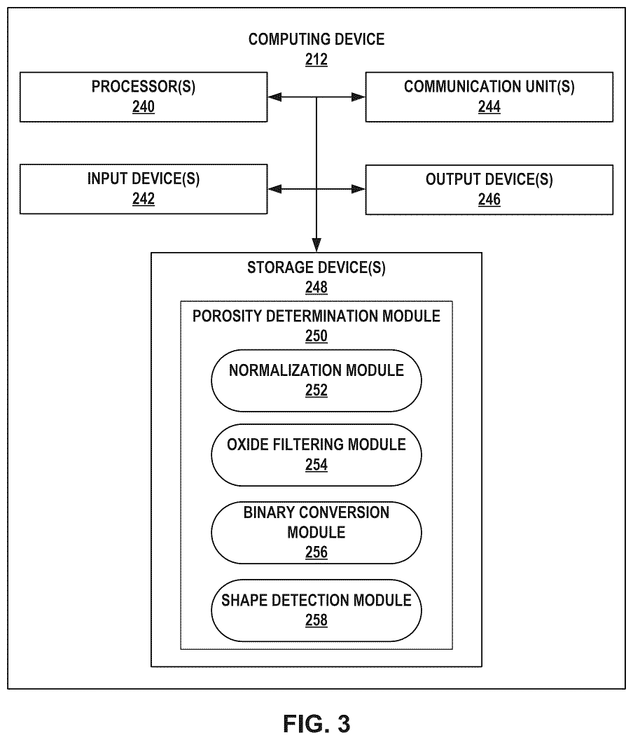

FIG. 3 is a conceptual block diagram illustrating an example of a computing device 212. Computing device 212 of FIG. 3 may be an example of computing device 112 of FIG. 2. In some examples, computing device 212 may include, for example, a desktop computer, a laptop computer, a workstation, a server, a mainframe, a cloud computing system, or the like. In some examples, computing device 212 may control the operation of system 100 of FIG. 2, including, for example, thermal spray gun 120, energy source 124, entry flowstream 130, exit flowstream 136, imaging device 140, spray material feed 150, and spray target 160. In other examples, computing device 212 may be separate from the rest of a thermal spray system, and may be configured only to process a captured image of a coating layer such as layer 10 of FIG. 1 or coating layer 124 of FIG. 2.

In the example illustrated in FIG. 3, computing device 212 includes one or more processors 240, one or more input devices 242, one or more communication units 244, one or more output devices 246, and one or more storage devices 248. In some examples, one or more storage devices 248 stores porosity determination module 250. In other examples, computing device 180 may include additional components or fewer components than those illustrated in FIG. 2.

One or more processors 240 are configured to implement functionality and/or process instructions for execution within computing device 212. For example, processors 240 may be capable of processing instructions stored by storage device 248. Examples of one or more processors 240 may include, any one or more of a microprocessor, a controller, a digital signal processor (DSP), an application specific integrated circuit (ASIC), a field-programmable gate array (FPGA), or equivalent discrete or integrated logic circuitry.

One or more storage devices 248 may be configured to store information within computing device 212 during operation. Storage devices 248, in some examples, include a computer-readable storage medium or computer-readable storage device. In some examples, storage devices 248 include a temporary memory, meaning that a primary purpose of storage device 248 is not long-term storage. Storage devices 248, in some examples, include a volatile memory, meaning that storage device 248 does not maintain stored contents when power is not provided to storage device 248. Examples of volatile memories include random access memories (RAM), dynamic random access memories (DRAM), static random access memories (SRAM), and other forms of volatile memories known in the art. In some examples, storage devices 248 are used to store program instructions for execution by processors 240. Storage devices 248, in some examples, are used by software or applications running on computing device 212 to temporarily store information during program execution.

In some examples, storage devices 248 may further include one or more storage device 248 configured for longer-term storage of information. In some examples, storage devices 248 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 212 further includes one or more communication units 244. Computing device 212 may utilize communication units 244 to communicate with external devices (e.g., thermal spray gun 120, entry flowstream 130, exit flowstream 136, acoustic sensor 140, spray material 150, and spray target 160) via one or more networks, such as one or more wired or wireless networks. Communication unit 244 may include a network interface card, such as an Ethernet card, an optical transceiver, a radio frequency transceiver, or any other type of device that can send and receive information. Other examples of such network interfaces may include Wi-Fi radios or Universal Serial Bus (USB). In some examples, computing device 212 utilizes communication units 244 to wirelessly communicate with an external device such as a server.

Computing device 212 also includes one or more input devices 242. Input devices 242, in some examples, are configured to receive input from a user through tactile, audio, or video sources. Examples of input devices 242 include a mouse, a keyboard, a voice responsive system, video camera, microphone, touchscreen, or any other type of device for detecting a command from a user.

Computing device 212 may further include one or more output devices 246. Output devices 246, in some examples, are configured to provide output to a user using audio or video media. For example, output devices 246 may include a display, a sound card, a video graphics adapter card, or any other type of device for converting a signal into an appropriate form understandable to humans or machines. In some example, computing device 212 outputs a representation of the image data captured by imaging device 140.

In some examples, computing device 212 may generate an alert in response to a determination of a state of system 100 or coating layer 124, via output devices 246. For example, computing device 212 may generate auditory signals, such as a beep, an alert tone, or an alerting sound, or visual signals, such as an icon on a display, flashing lights, or a combination of visual and audible signals, to indicate a process variance or a process parameter deviation. For example, the alert may be generated in response to a determination by computing device 212 that coating layer 124 defines a porosity that falls outside a predetermined range for target porosity. In some examples, an operator may thus be alerted, and may choose to investigate thermal spray system 100. As another example, computing device 212 may generate an alert that is transmitted over a network to another computing device, including a hand-held computing device, for instance, a cellphone. The alert signal may include information about the coating parameter or process parameter.

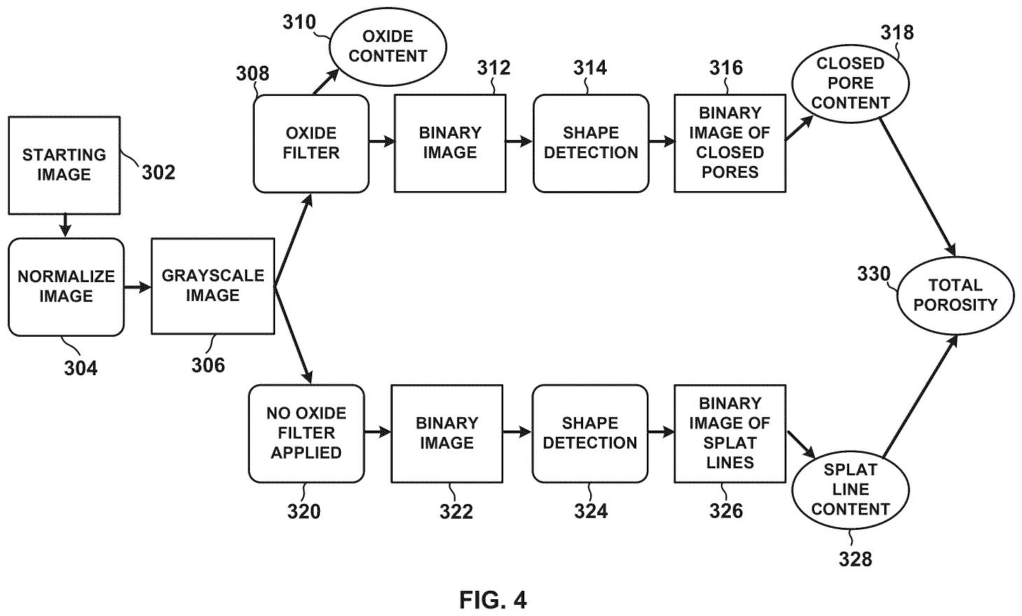

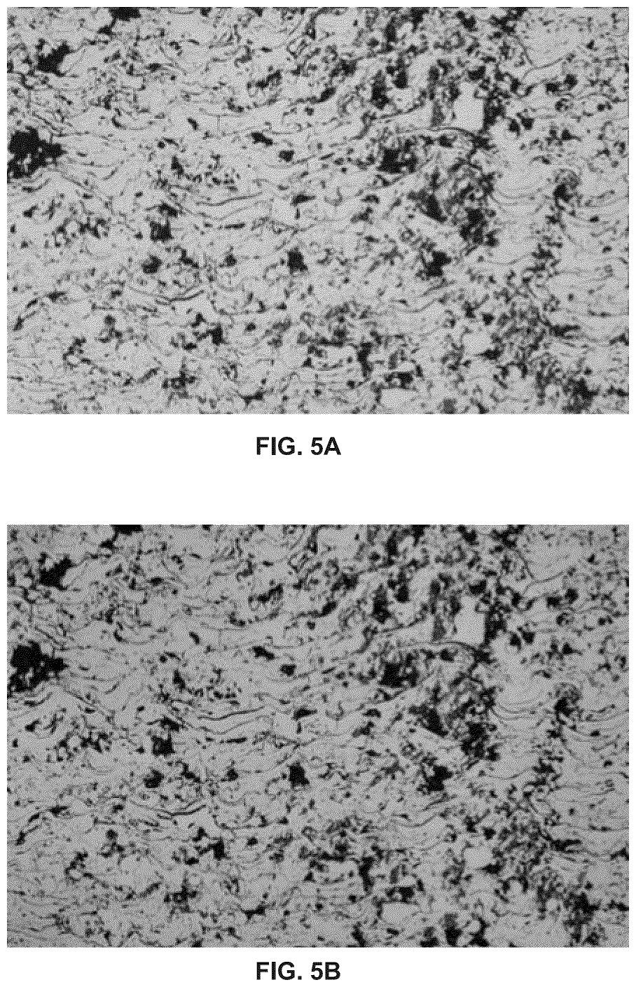

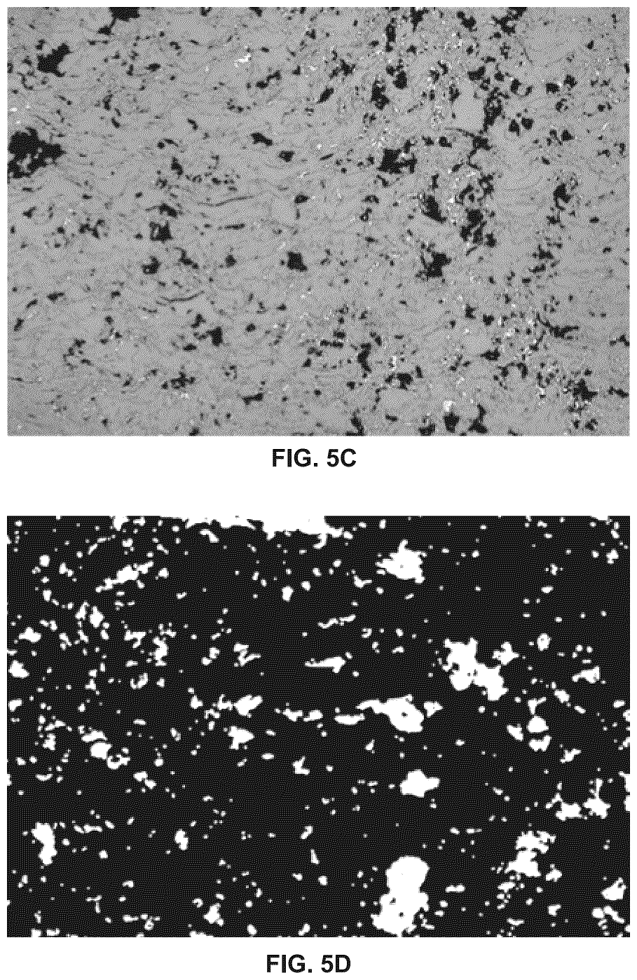

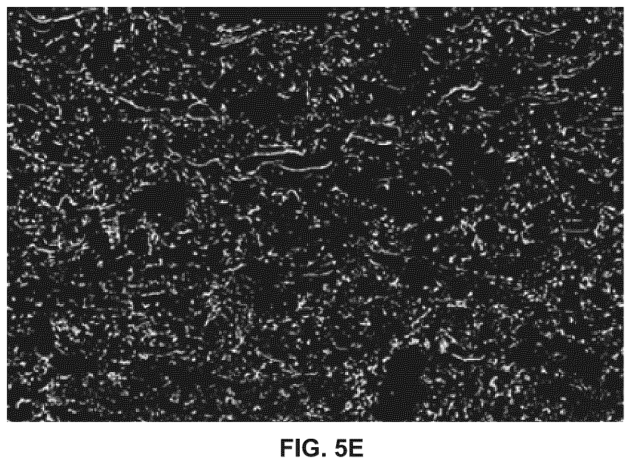

Storage devices 248 of computing device 212 may include porosity determination module 250. In some examples, porosity determination module 250 processes the image or images captured by imaging device 140 to determine a porosity of coating layer 124. Porosity determination module 250 may determine a total porosity of coating layer 124, and may provide more granular information about coating layer 124 including an oxide content, a closed porosity, and/or a splat line porosity. To determine these characteristics of coating layer 124, porosity determination module 250 may include sub-modules configured to execute specific functions on the received image. Functions performed by normalization module 252, oxide filtering module 254, binary conversion module 256, and shape detection module 258 are explained below with reference to the example flow diagram illustrated in FIG. 4 and the example images at various stages of the process of FIG. 4 of FIGS. 5A-5E.

Porosity determination module 250 and its sub-modules normalization module 252, oxide filtering module 254, binary conversion module 256, and shape detection module 258 may be implemented in various ways. For example, normalization module 252, oxide filtering module 254, binary conversion module 256, and shape detection module 258 may be implemented as software, such as an executable application or an operating system, or firmware executed by one or more processors 240. In other examples, normalization module 252, oxide filtering module 254, binary conversion module 256, and shape detection module 258 may be implemented as part of a hardware unit of computing device 212.

Computing device 212 may include additional components that, for clarity, are not shown in FIG. 3. For example, computing device 212 may include a power supply to provide power to the components of computing device 212. Similarly, the components of computing device 212 shown in FIG. 3 may not be necessary in every example of computing device 212.

Examples of layer 10, thermal spray system 100, and computing device 212 are described with reference to FIGS. 1-3 above. The technique of FIG. 4 is described with reference to an example image of layer 10 of FIG. 1 and system 100 of FIG. 2 as processed by computing device 212 of FIG. 3. Various stages of the image processing technique of FIG. 4 are shown in FIGS. 5A-5E. Operations of computing device 212 are illustrated in FIG. 4 in boxes with rounded corners. Outputs of computing device 212 are illustrated as ellipses in the flow diagram of FIG. 4

Computing device 212 may receive the image of FIG. 5A (302). The image of FIG. 5A may be the raw image captured by imaging device 140, and may be representative of a cross-section of layer 10 deposited by thermal spray system 100. The received image may include a matrix of pixels, with each pixel in the matrix having a luminance value.

Normalization module 252 may normalize the image of FIG. 5A (304), resulting in the grayscale image of FIG. 5B (306). Although the image if FIG. 5A does not include colors other than black and white, in some examples the image of FIG. 5A may include colors other than black and white. Each pixel in the matrix of pixels may define a luminance value. The luminance value may be the brightness intensity. In some examples, the brightness intensity may range from a luminance value of zero to indicate a black color to a luminance value of, for example, 255 to indicate a white color. Other scales of luminance values are also considered. Further, other examples are also considered, such as where the maximum luminance value is indicative of a black color and the minimum luminance value is indicative of a white color. In examples where the image of FIG. 5A is a color image, each pixel in the matrix of pixels may include a luminance value for each of a red color, a yellow color, and a blue color. In such examples, normalization module 252 may remove the color and assign an overall luminance value to the pixel on black and white scale. Normalization module 252 may determine an overall luminance value for each pixel by, for example, summing or averaging the luminance values for each of the red color, the yellow color, and the blue color.

Normalization module 252 may normalize the image of FIG. 5A to generate the grayscale image of FIG. 5B. The grayscale image of FIG. 5B has reduced brightness gradients that may result from the way the image is captured or other artificial means. For example, a camera flash may cause a central portion of the image to appear brighter than the perimeter of the image, and normalizing the image may correct for the camera flash. In some examples, normalizing the image may include adjusting, by normalization module 252, the luminance value of at least one pixel of the matrix of pixels. For example, adjusting the luminance value of at least one pixel may include determining a background luminance value for each individual pixel in the matrix of pixels in FIG. 5A, and subtracting the background luminance value from each individual pixel luminance value to create the grayscale image of FIG. 5B. The resulting grayscale image of FIG. 5B may result in a more accurate representation of layer 10 in the image relative to techniques which do not employ normalization module 252, because the grayscale image may correct for non-uniform illumination of the cross-section of layer 10 by reducing or eliminating brightness gradients. Normalization module 252 may generate the grayscale image of FIG. 5B by normalizing and/or removing color from the raw image of FIG. 5A. Porosity determination module 250 may execute normalization module 252 to generate the grayscale image prior to determining at least one pixel that corresponds to the oxide components 20 in layer 10. Thus, further analysis of the image may be performed on an image that is relatively free of noise introduced through non-uniform illumination.

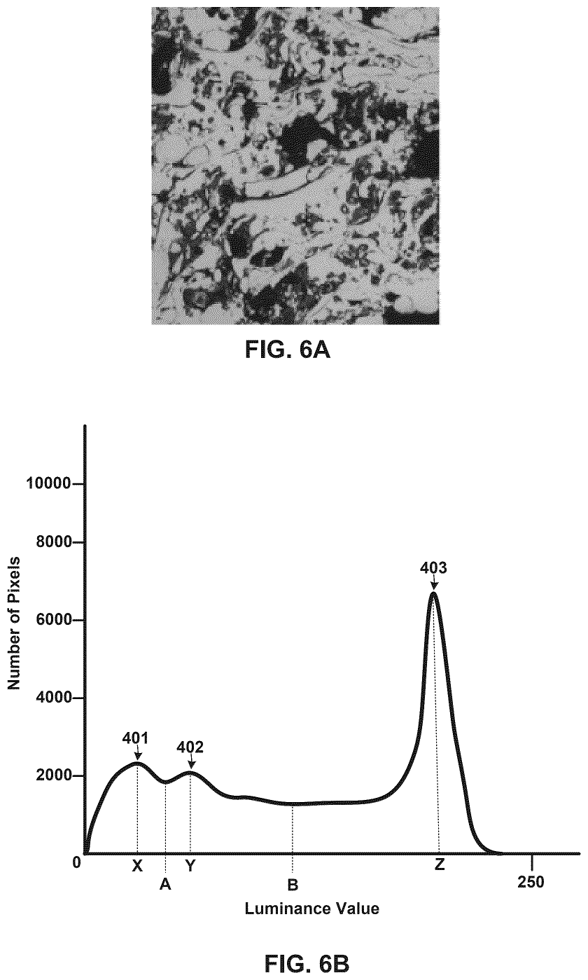

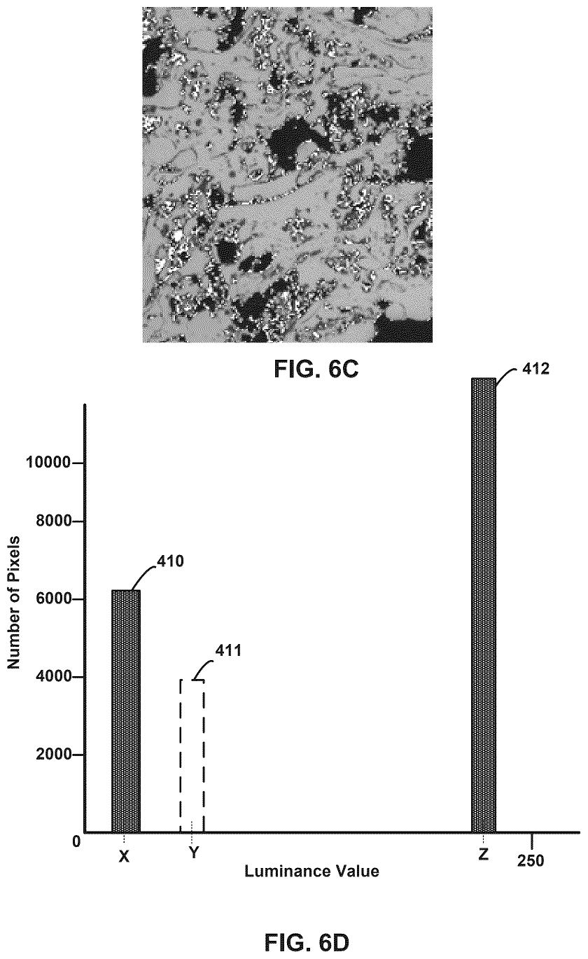

At this juncture, the technique of FIG. 4 may split into parallel branches. The upper branch may include oxide filtering (308) by oxide filtering module 254 a first version of the image of FIG. 5B to create an oxide-filtered image with pixels corresponding to oxide components 20 removed. The matrix of pixels making up the raw image of FIG. 5A may be modified to include fewer pixels, and the oxide-filtered image may be generated from the modified matrix of pixels, as shown in FIG. 5C. Oxide filtering may be executed by oxide filtering module 254, as will be further described below with respect to FIGS. 6A-6D.

Staying on the upper branch of FIG. 4, binary conversion module 256 may convert the oxide-filtered image of FIG. 5C into a binary image (312). In some examples, binary conversion module 256 may assign each pixel in the matrix of pixels to a luminance value that is equal to a luminance value of a black color or a luminance value that is equal to a white color. By way of example, if the scale of luminance values ranges from zero to 255, those pixels that have a luminance value from zero to 127 may be adjusted to have a luminance value of zero by binary conversion module 256. Accordingly, those pixels that have a luminance value from 128 to 255 may be adjusted to have a luminance value of 255. In this way, binary conversion module 256 may convert the oxide-filtered image of FIG. 5C image into a binary image consisting of only pixels that are white or black.

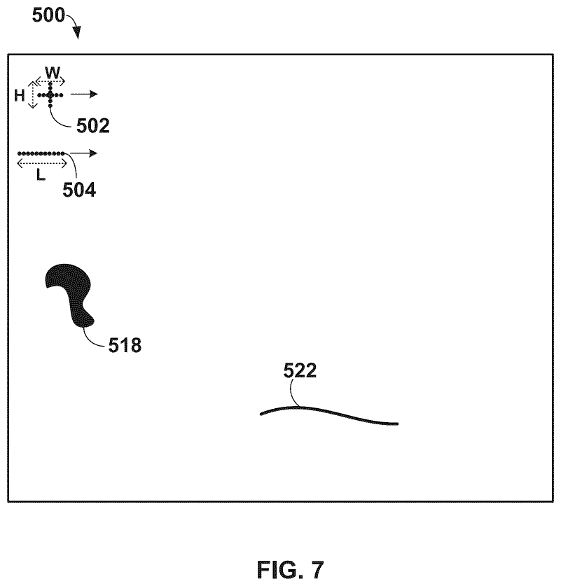

Shape detection module 256 may perform shape detection (314) to create a binary image of closed pores (316). Execution of shape detection by shape detection module 256 is further described below with respect to FIG. 7. Using the binary image of closed pores of FIG. 5D, computing device 212 may sum the pixels indicative of closed pores 18 and compare the number of pixels indicative of closed pores 18 against the total number of pixels in the original image of FIG. 5A. The fraction of pixels indicative of closed pores 18 may directly correspond to the volume percentage of closed pores 18 in layer 10. Thus, computing device 212 may determine the closed pore content of coating layer (318).

Turning to the lower branch of FIG. 4, a second copy of the grayscale image of FIG. 5B may be generated by computing device 212. Unlike on the upper branch, no oxide filter is applied to the second version of the image of FIG. 5B (320). In other words, processors 240 may not instruct oxide filtering module 254 to act on the image. In some examples, oxide filtering may undesirably remove splat lines 22, as the image resolution of splat lines 22 may make splat lines appear gray or dark gray instead of black. Binary conversion module 256 may convert the image of FIG. 5B to a binary image as described above (322). Shape detection module 258 may execute shape detection (324) to identify pixels that correspond to splat lines 22 in the image of FIG. 5E, which results in a binary image of splat lines (326). Execution of shape detection module 258 with respect to the identification of splat lines is further described below with reference to FIG. 7. Computing device 212 may compare the number of pixels indicative of splat lines 22 in FIG. 5E against the total number of pixels in the original image of FIG. 5A. The fraction of pixels indicative of splat lines 22 may directly correspond to the volume percentage of closed pores 18 in layer 10. Thus, computing device 212 may determine the splat line porosity of layer 10 (328).

The technique of FIG. 4 further includes summing, by porosity determination module 250, the closed pore porosity and the splat line porosity to determine a total porosity of layer 10 (330). Determining the closed pore porosity (318), splat line porosity (328), and total porosity (330) may be advantageous relative to making a single determination of total porosity because closed pore porosity and splat line porosity may impact the performance of layer 10 in different ways. For example, the fraction of the total porosity due to closed pores may correlate to the erosion resistance and/or abrasion resistance of layer 10. Similarly, the fraction of the total porosity due to splat lines may correlate to the susceptibility of the coating layer to delaminate.

FIGS. 6A-6D are conceptual diagrams illustrating an example oxide filtering step 308 of FIG. 4. FIG. 6A illustrates a portion of the grayscale image of FIG. 5B. FIG. 6B is a frequency chart illustrating the number of pixels (y-axis) with each luminance value of the plurality of luminance values (x-axis) is present in the image of FIG. 6A. FIG. 6C illustrates an oxide-filtered image of the raw image of FIG. 6A, after oxide filtering module 254 has, through local thresholding, identified and removed pixels corresponding to oxide components (20, FIG. 1). FIG. 6D is a bar chart illustrating oxide filtering module 254 using local thresholding to identify peaks in the frequency chart of FIG. 6B, determine a threshold matching range of luminance values surrounding the first luminance value, set the luminance value of pixels with a luminance value within the threshold matching range to the first luminance value, determine a local peak frequency corresponding to oxide components 20 (FIG. 1), and remove the pixels with a luminance value equal to the local peak frequency to filter oxide components 20 from the image. FIGS. 6A-6D further illustrate an example oxide filtering step 308 of FIG. 4.

Oxide filtering module 254 may determine, based on the luminance values of the matrix of pixels of FIG. 5B, one or more pixels that correspond to an oxide component or oxide components 20 in layer 10. As can be seen in FIG. 6A, a visual review of a photograph of layer 10, pixels that correspond to void volumes (e.g., closed pores 18 or splat lines 22) have low luminance values, appearing black or nearly black. Similarly, pixels that correspond to oxide components 20 have relatively low luminance values, appearing dark gray or nearly black. Visual review, or a conversion of FIG. 6A into a binary image by binary conversion module 258, may result in pixels that correspond to oxide components 20 being grouped with those pixels that correspond to void volumes in layer 10.

To distinguish between oxide components 20 and void volumes, oxide filtering module 254 may perform local thresholding. In some examples, oxide filtering module 254 may perform local thresholding by plotting each pixel of the plurality of pixels according to its luminance value, as shown in the frequency plot of FIG. 6B. The plotting step may also be called applying a fast fourier transform (FFT).

Oxide filtering module 254 may determine local peak frequencies 401, 402, and 403 of pixels with particular luminance values X, Y, and Z. Oxide filtering module 254 may set the values of pixels with a luminance value near local peak frequency 401 occurring at luminance value X to luminance value X, set the luminance value of pixels near local peak frequency 402 occurring at luminance value of Y to luminance value Y, and set the luminance value of pixels with a luminance value near local peak frequency 403 occurring at local peak frequency at luminance value Z to luminance value Z. In some examples, to determine the cutoff point between which pixels should be assigned luminance value X and which pixels should be assigned luminance value Y, oxide filtering module 254 may determine a local minimum frequency occurring at luminance value A between local peak frequencies 401 and 402. Similarly, to determine the cutoff point between which pixels should be assigned luminance value Y and which pixels should be assigned luminance value Z, oxide filtering module 254 may determine a local minimum frequency occurring at luminance value B between local peak frequencies 402 and 403.

Oxide filtering module 254 may set pixels with a luminance value lower than A to luminance value X, pixels with a luminance value greater than or equal to A and less than or equal to B to luminance value Y, and pixels with a luminance value greater than B to luminance value Z. Accordingly, oxide filtering module 254 may group the pixels in image FIG. 6A, which range in luminance value across the scale of luminance values as shown in FIG. 6B, into three groups, with the three groups having luminance values of X, Y, and Z, respectively. The resulting plot is shown as a bar chart in FIG. 6D, with the three bars labeled bars 410, 411, and 412 respectively. Oxide filtering module 254 may determine that bar 410 corresponds to closed pores 18 within layer 10, bar 411 corresponds to oxide components 20 within layer 10, and bar 412 corresponds to metal, ceramic, or alloy components within lamellae 14 of layer 10.

In some examples, oxide filtering module 254 may perform local thresholding using a threshold matching range. For examples, oxide filtering module 254 may determine a threshold matching range of luminance values surrounding luminance value X. The threshold matching range may be those luminance values with brightness intensity within 10 intensity units, or within 20 intensity units, or within 30 intensity units, of luminance value X. Oxide filtering module 254 may set the luminance values of pixels withing the threshold matching range surrounding luminance value X to luminance value X. In this way, oxide filtering module 254, through local thresholding, may group a set of pixels that correspond to oxide components 20 as having the same luminance value.

To determine which bar corresponds to which component of layer 10, oxide filtering module may assign bar 410 occurring at the lowest luminance value X to closed pores 18, assign bar 411 occurring at middle luminance value Y to oxide components 20, and assign bar 412 occurring at highest luminance value Z to metal, ceramic, or alloy components of layer 10. By counting the number of pixels in bar 411 and comparing the number of pixels in bar 411 to the total number of pixels in bars 410, 411, and 412 combined, oxide filtering module 254 may determine the oxide content of layer 10.

In some examples, oxide filtering module 254 removes the one or more pixels that correspond to oxide components 20 in bar 411 from the matrix of pixels that make up the raw image to form a modified matrix of pixels. Oxide filtering module 254 may generate an oxide-filtered image from the modified matrix of pixels, as shown in FIG. 6C. By removing the pixels that correspond to oxide components 20, oxide filtering module 254 may prevent overcounting or undercounting the pixels that correspond to oxide components 20 in subsequent steps where the closed pore porosity is measured, as described above with respect to FIG. 4.

In some examples, oxide filtering module 254 may perform oxide filtering using luminance-independent techniques described herein. For example, oxide-filtering 254 may, through local thresholding, locate and identify three peaks. Regardless of the luminance values of the different peaks, oxide filtering module 254 may determine that the peaks are indicative of void volumes, oxide components, and metal and/or ceramic components of the layer. Advantageously, the disclosed luminance-independent techniques may thus be used on various types of images, with various levels of image lighting and/or quality, representative of various types of layers, because the oxide filtering module 254 may still find three peaks where one peak corresponds to oxide components 20.

FIG. 7 is a conceptual diagram illustrating an example execution process for shape detection module 258 of computing device 212. Shape detection module 258 may be executed to generate an image of closed pores 18 (step 314 of FIG. 4), or may be executed to generate an image of splat lines 22 (step 324 of FIG. 4), or both. As described in FIG. 4, shape detection module 258 may be executed to identify and quantify closed pores 18 separately from execution of shape detection module 258 to identify and quantify splat lines 22. However, in some examples, shape detection module may execute more than one shape detection module 258 on the same image at the same time, as will be described with respect to FIG. 7.

FIG. 7 illustrates image 500, which may be an example of FIG. 1, as acted on by shape detection module 258. Image 500 includes only a single closed pore 518 and a single splat line 522 for clarity, although additional closed pores and splat lines may be present, similar to FIG. 1. Shape detection module 258 may determine that shape 502 of a connected subplurality of pixels in the matrix of pixels all with a luminance value of zero (or another luminance value indicative of a black color, or of a white color in some images) is indicative of closed pore 518 within image 500. In some examples, shape 502 may be a cross, as illustrated, although other shapes including a square, a circle, or the like are also considered. Shape 502 may define dimension W, which may be the number of adjacent pixels which must all define a luminance value of zero in a first direction. Shape 502 may similarly define dimension L, which may be the number of pixels that all must define a luminance value of zero in a second direction perpendicular to the first direction. In some examples, dimensions W and L may have a magnitude of at least two pixels, at least three pixels, at least four pixels, or the like.

Shape detection module 258 may scan shape 502 across image 500. In some examples, scanning includes traversing back and forth across image 500, up and down across image 500, and rotating shape 502 about itself. By scanning shape 502 across image 500, shape detection module 258 may identify closed pore 518 as a closed pore by determining that there is at least one location and orientation of shape 502 that includes only pixels with a luminance value of zero. After identifying closed pore 518, shape detection module 258 may determine a boundary of the identified closed pore 518 by grouping all pixels of the matrix of pixels that have a luminance value of zero and are part of an connected cluster of adjacent pixels that includes a pixel that is part of shape 502 as part of the closed pore 518. In this way, shape detection module may accurately identify and determine the dimensions of closed pore 518. By summing all pixels that are part of closed pore 518 or another identified closed pore within image 500 and comparing the number of pixels to the total number of pixels in the matrix of pixels making up image 500, shape detection module 258 may determine a closed pore porosity of layer 10.

Additionally, or alternatively, shape detection module 258 may be executed to identify the splat line porosity of image 500 and thus layer 10. To determine the splat line porosity, shape detection module 258 may identify splat line 522 within image 500. For example, shape detection module 258 may identify splat line 522 by determining that an uninterrupted chain 504 of adjacent pixels in the matrix of pixels all with a luminance value of zero that meets a threshold length L is indicative of a splat line. In some examples, uninterrupted chain 504 need not form a straight line; the member pixels of uninterrupted chain 504 may be adjacent at any angle or combination of angles in the matrix of pixels that make up image 500. After identifying splat line 522, shape detection module 258 may determine an actual length of splat line 522 by grouping all pixels of the matrix of pixels that have a luminance value of zero and are part of the uninterrupted chain of adjacent pixels as part of splat line 522. To determine a splat line porosity, shape detection module 258 may sum all pixels that are part of splat line 522 or another identified splat line in image 500 to determine the splat line porosity. In some examples, shape detection module 258 may identify splat line 522 by determining that each pixel that is part of splat line 522 is sandwiched between pixels that do not have a luminance value of zero.

In some examples, shape detection module 258 may be selectively tailored such that the shape and size of shape 502 and/or uninterrupted chain 504 may detect closed pores 518 and/or splat lines 522 in a specific layer at a specific magnification. The dimensions of shape 502 and/or uninterrupted chain 504, as well as settings of imaging device 140, may be calibrated for a particular layer 10, for example through experimental methods, or through machine learning methods.

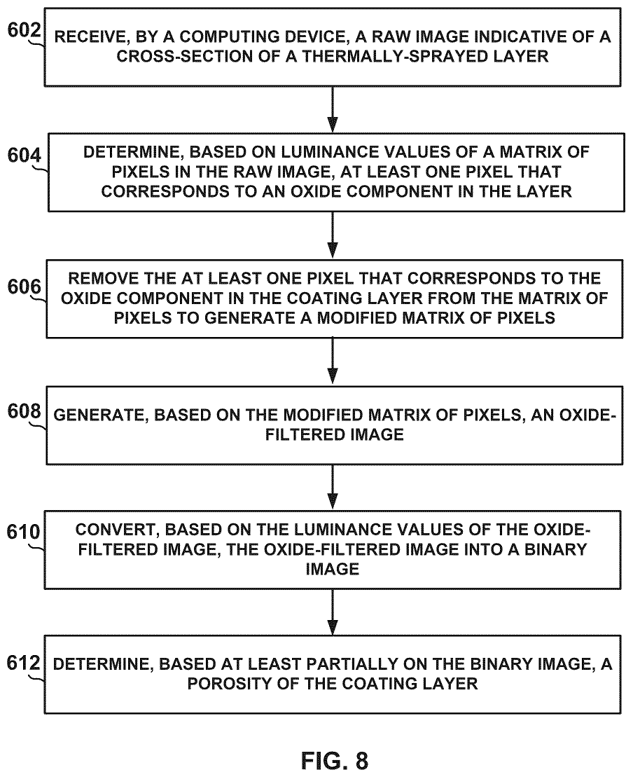

FIG. 8 is a flowchart illustrating an example technique for determining a porosity of a coating layer, according to one or more examples of the present disclosure. The technique of FIG. 8 will be described with reference to layer 10 of FIG. 1, thermal spray system 100 of FIG. 2, and computing device 212 of FIG. 3, although the layer 10 may deposited by another system using another technique. Furthermore, the described technique may be used to deposit other coating layers, and may be performed using other systems.

Computing device 212 may receive a raw image indicative of a cross-section of layer 10 (602). In some examples, the raw image indicative of a cross-section of layer 10 (e.g., FIG. 1) may be received by computing device 212, and the raw image may include a matrix of individual pixels. The raw image may be captured by imaging device 140. The raw image may be a micrograph, and may be in black and white or in color. Each pixel in the matrix of pixels may define a luminance value. The luminance value may be the brightness intensity. In some examples, the brightness intensity may range from a luminance value of zero to indicate a black color to a luminance value of, for example, 255 to indicate a white color. Other scales of luminance values are also considered. Further, other examples are also considered, such as where the maximum luminance value is indicative of a black color and the minimum luminance value is indicative of a white color. In examples where the image is a color image, each pixel in the matrix of pixels may include a luminance value for each of a red color, a yellow color, and a blue color. In some examples, the technique may include determining an overall luminance value by, for example, summing or averaging the luminance values for each of the red color, the yellow color, and the blue color. The technique may then proceed based on the determined overall luminance value.

In some examples, normalizing module 252 may normalize the raw image to generate a grayscale image. The grayscale image may have reduced or eliminated brightness gradients that may result from the way the raw image is captured or other artificial means. For example, a flash associated with imaging device 140 may cause a central portion of the raw image to appear brighter than the perimeter of the image, and executing normalization module 252 may correct for the camera flash. In some examples, normalization module 252 may adjust a luminance value of at least one pixel of the matrix of pixels. For example, adjusting the luminance value of at least one pixel may include determining a background luminance value for each individual pixel in the matrix of pixels, and subtracting the background luminance value from each individual pixel luminance value. The resulting normalized image may be a grayscale image (FIG. 5B), which may result in a more accurate representation of layer 10.

Oxide filtering module 254 may determine, based on luminance values of a matrix of pixels in the grayscale image, at least one pixel that corresponds to oxide components 20 in layer 10 (604). In some examples, to determine that at least one pixel that corresponds to oxide components 20, oxide filtering module 254 may perform local thresholding, as described above with respect to FIGS. 6A-6C. Oxide filtering module 254 may identify and quantify at least one pixel corresponding to oxide components 20. Oxide filtering module 254 may remove the one or more pixels that correspond to oxide components 20 in layer 10 from the matrix of pixels to generate a modified matrix of pixels (606). In some examples, oxide filtering module may generate, based on the modified matrix, an oxide filtered image (608), as illustrated in FIG. 6C. In some examples, oxide filtering module 254 may remove the one or more pixels corresponding to oxide components 20 (FIG. 6C) prior to determining a closed pore porosity of layer 10.

Binary conversion module 256 may convert, based on the luminance values, the oxide-filtered image into a binary image (610). In some examples, the computing device may assign each pixel in the matrix of pixels to a luminance value that is equal to a luminance value of a black color or a luminance value that is equal to a white color. By way of example, if the scale of luminance values ranges from zero to 255, those pixels that have a luminance value from zero to 127 may be adjusted to have a luminance value of zero. Accordingly, those pixels that have a luminance value from 128 to 255 may be adjusted to have a luminance value of 255. In this way, the image may be converted into a binary image consisting of only pixels that are white or black.

Porosity determination module 250 may determine a porosity of layer 10 (612). In some examples, the porosity may be a total porosity, and executing porosity determination module 250 may include determining a closed pore porosity, which may be the total volume of closed pores 18 within layer 10. Porosity determination module 250 may also include determining a splat line porosity, which may be the total volumes of splat lines 22 within layer 10.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following examples and claims.
Example 1: A method includes receiving, by a computing device, a raw image indicative of a cross-section of a thermally-sprayed layer, wherein the raw image comprises a matrix of pixels, each pixel in the matrix of pixels defining a respective luminance value of a plurality of luminance values; determining, by the computing device and based on the plurality of luminance values, at least one pixel of the matrix of pixels that corresponds to an oxide component in the layer; removing, by the computing device, the at least one pixel that corresponds to the oxide component in the layer from the matrix of pixels to generate a modified matrix of pixels; generating, by the computing device and based on the modified matrix of pixels, an oxide-filtered image; converting, by the computing device and based on the luminance values of the oxide-filtered image, the oxide-filtered image into a binary image; and determining, by the computing device, based at least partially on the binary image, a porosity of the thermally-sprayed layer.
Example 2: The method of example 1, further comprising normalizing the raw image to generate a grayscale image, wherein normalizing the image comprises adjusting, by the computing device, a luminance value of at least one pixel of the matrix of pixels in the raw image.
Example 3: The method of example 2, wherein normalizing the image comprises correcting for non-uniform illumination of the cross-section of the thermally-sprayed layer by reducing or eliminating brightness gradients within the raw image.
Example 4: The method of any of examples 2 and 3, wherein generating the grayscale image is performed prior to determining the at least one pixel that corresponds to the oxide component in the thermally-sprayed layer.
Example 5: The method of any of examples 1 through 4, wherein determining the at least one pixel that corresponds to the oxide component comprises determining an oxide content of the thermally-sprayed layer.
Example 6: The method of any of examples 1 through 5, wherein determining the one or more pixels that correspond to the oxide component comprises performing local thresholding, wherein performing local thresholding comprises: plotting each pixel of the matrix of pixels according to a respective luminance value of the pixel, determining a local peak frequency of pixels with a particular luminance value occurring at a first luminance value, determining a threshold matching range of luminance values surrounding the first luminance value, setting the luminance value of pixels with a luminance value within the threshold matching range to the first luminance value, and determining that the plurality of pixels with the first luminance value correspond to the oxide component in the thermally-sprayed layer.
Example 7: The method of example 6, wherein the local peak frequency of pixels is a first local peak frequency, and local thresholding further comprises determining a second local peak frequency and a third local peak frequency, wherein the second local peak frequency is indicative of void volumes within the coating layer and the third local peak frequency is indicative of metal, ceramic or alloy components within the thermally-sprayed layer.
Example 8: The method of any of examples 6 and 7, wherein removing the at least one pixel that corresponds to the oxide component in the thermally-sprayed layer from the matrix of pixels comprises removing the plurality of pixels with the first luminance value from the matrix of pixels.
Example 9: The method of any of examples 1 through 8, wherein converting the image into a binary image comprises assigning each respective pixel in the modified matrix of pixels that make up the oxide-filtered image to a luminance value that is equal to a luminance value of a black color or a luminance value that is equal to a white color.
Example 10: The method of example 9, wherein the luminance value that is equal to a black color is zero.
Example 11: The method of example 10, wherein the determined porosity of the coating layer is a total porosity, and wherein determining the porosity of the coating layer further comprises determining a closed pore porosity and a splat line porosity.
Example 12: The method of example 11, wherein determining the closed porosity comprises executing a shape detection module, wherein executing the shape detection module comprises: determining that a shape of a connected subplurality of pixels in the matrix of pixels each having a respective luminance value of zero is indicative of a closed pore, identifying at least one closed pore in the image by finding the shape within the matrix of pixels, determining a boundary of the at least one closed pore by grouping all pixels of the matrix of pixels that have a luminance value of zero and are part of a connected cluster of adjacent pixels that includes a pixel that is part of the shape as part of the at least one closed pore, and summing all pixels that are part of the at least one closed pore to determine the closed pore porosity.
Example 13: The method of any of examples 11 and 12, wherein determining the splat line porosity comprises executing a shape detection module, wherein executing the shape detection module comprises: determining that an uninterrupted chain of adjacent pixels in the matrix of pixels all with a luminance value of zero that meets a threshold length is indicative of a splat line, identifying at least one splat line in the image by finding the uninterrupted chain that meets the threshold length within the matrix of pixels, determining an actual length of the identified splat line of the identified splat line by grouping all pixels of the matrix of pixels that have a luminance value of zero and are part of the uninterrupted chain of adjacent pixels as part of the at least one splat line, and summing all pixels that are part of the at least one splat line to determine the splat line porosity.
Example 14: The method of example 13, wherein identifying the at least one splat line comprises determining that each pixel that is part of the at least one splat line is sandwiched between pixels that do not have a luminance value of zero.
Example 15: The method of any of examples 11 through 14, wherein the closed pore porosity is determined at least partially by converting the oxide-filtered image into a first binary image; and wherein the splat line porosity is determined at least partially by converting the raw image into a second binary image.
Example 16: The method of any of examples 1 through 15, further comprising comparing the determined porosity to a predetermined target range, and responsive to determining that the determined porosity does not fall within the predetermined target range, controlling, by the computing device, at least one parameter of a thermal spray gun configured to apply the thermally-sprayed coating.
Example 17: A non-transitory computer-readable storage medium having stored thereon instructions that, when executed, configure a processor to: receive a raw image indicative of a cross-section of a thermally-sprayed layer, wherein the raw image comprises a matrix of pixels, each pixel in the matrix of pixels defining a respective luminance value of a plurality of luminance values; determine, based on the plurality of luminance values, at least one pixel of the matrix of pixels that corresponds to an oxide component in the layer; remove the at least one pixel that corresponds to the oxide component in the layer from the matrix of pixels to generate a modified matrix of pixels; generate, based on the modified matrix of pixels, an oxide-filtered image; convert, based on the luminance values of the oxide-filtered image, the oxide-filtered image into a binary image; and determine, based at least partially on the binary image, a porosity of the thermally-sprayed layer.
Example 18: The non-transitory computer readable storage medium of example 17, wherein, to determine the one or more pixels that correspond to the oxide component, the instruction further configure the processor to perform a local thresholding operation which comprises: plotting each pixel of the matrix of pixels according to a respective luminance value of the pixel, determining a local peak frequency of pixels with a particular luminance value occurring at a first luminance value, determining a threshold matching range of luminance values surrounding the first luminance value, setting the luminance value of pixels with a luminance value within the threshold matching range to the first luminance value, and determining that the plurality of pixels with the first luminance value correspond to the oxide component in the coating layer.
Example 19: The non-transitory computer readable storage medium of any of examples 17 and 18, wherein the local peak frequency of pixels is a first local peak frequency, and local thresholding further comprises determining a second local peak frequency and a third local peak frequency, wherein the second local peak frequency is indicative of void volumes within the coating layer and the third local peak frequency is indicative of metal or alloy components within the coating layer.
Example 20: A system includes a thermal spray gun configured to apply a thermally-sprayed layer to a substrate; an imaging device configured to capture an image indicative of a cross-section of the thermally spraying layer, wherein the image comprises a matrix of pixels, each pixel in the matrix of pixels defining a luminance value; and a computing device configured to: receive a raw image indicative of a cross-section of a thermally-sprayed layer, wherein the raw image comprises a matrix of pixels, each pixel in the matrix of pixels defining a respective luminance value of a plurality of luminance values; determine, based on the plurality of luminance values, at least one pixel of the matrix of pixels that corresponds to an oxide component in the layer; remove the at least one pixel that corresponds to the oxide component in the layer from the matrix of pixels to generate a modified matrix of pixels; generate by the computing device and based on the modified matrix of pixels, an oxide-filtered image; convert by the computing device and based on the luminance values of the oxide-filtered image, the oxide-filtered image into a binary image; and determine, based at least partially on the binary image, a porosity of the thermally-sprayed layer.

What is claimed is:

1. A method comprising:
receiving, by a computing device, a raw image indicative of a cross-section of a thermally-sprayed layer, wherein the raw image comprises a matrix of pixels, each pixel in the matrix of pixels defining a respective luminance value of a plurality of luminance values;
determining, by the computing device and based on the plurality of luminance values, at least one pixel of the matrix of pixels that corresponds to an oxide component in the layer;
removing, by the computing device, the at least one pixel that corresponds to the oxide component in the layer from the matrix of pixels to generate a modified matrix of pixels;
generating, by the computing device and based on the modified matrix of pixels, an oxide-filtered image;
converting, by the computing device and based on the luminance values of the oxide-filtered image, the oxide-filtered image into a binary image; and
determining, by the computing device, based at least partially on the binary image, a porosity of the thermally-sprayed layer.

2. The method of claim 1, further comprising normalizing the raw image to generate a grayscale image, wherein normalizing the image comprises adjusting, by the computing device, a luminance value of at least one pixel of the matrix of pixels in the raw image.

3. The method of claim 2, wherein normalizing the image comprises correcting for non-uniform illumination of the cross-section of the thermally-sprayed layer by reducing or eliminating brightness gradients within the raw image.

4. The method of claim 2, wherein generating the grayscale image is performed prior to determining the at least one pixel that corresponds to the oxide component in the thermally-sprayed layer.

5. The method of claim 1, wherein determining the at least one pixel that corresponds to the oxide component comprises determining an oxide content of the thermally-sprayed layer.

6. The method of claim 1, wherein determining the one or more pixels that correspond to the oxide component comprises performing local thresholding, wherein performing local thresholding comprises:
plotting each pixel of the matrix of pixels according to a respective luminance value of the pixel,
determining a local peak frequency of pixels with a particular luminance value occurring at a first luminance value,
determining a threshold matching range of luminance values surrounding the first luminance value,
setting the luminance value of pixels with a luminance value within the threshold matching range to the first luminance value, and
determining that the plurality of pixels with the first luminance value correspond to the oxide component in the thermally-sprayed layer.

7. The method of claim 6, wherein the local peak frequency of pixels is a first local peak frequency, and local thresholding further comprises determining a second local peak frequency and a third local peak frequency,
wherein the second local peak frequency is indicative of void volumes within the coating layer and the third local peak frequency is indicative of metal, ceramic or alloy components within the thermally-sprayed layer.

8. The method of claim 6, wherein removing the at least one pixel that corresponds to the oxide component in the thermally-sprayed layer from the matrix of pixels comprises removing the plurality of pixels with the first luminance value from the matrix of pixels.

9. The method of claim 1, wherein converting the image into a binary image comprises assigning each respective pixel in the modified matrix of pixels that make up the oxide-filtered image to a luminance value that is equal to a luminance value of a black color or a luminance value that is equal to a white color.

10. The method of claim 9, wherein the luminance value that is equal to a black color is zero.

11. The method of claim 10, wherein the determined porosity of the coating layer is a total porosity, and wherein determining the porosity of the coating layer further comprises determining a closed pore porosity and a splat line porosity.

12. The method of claim 11, wherein determining the closed porosity comprises executing a shape detection module, wherein executing the shape detection module comprises:
determining that a shape of a connected subplurality of pixels in the matrix of pixels each having a respective luminance value of zero is indicative of a closed pore,
identifying at least one closed pore in the image by finding the shape within the matrix of pixels,
determining a boundary of the at least one closed pore by grouping all pixels of the matrix of pixels that have a luminance value of zero and are part of a connected cluster of adjacent pixels that includes a pixel that is part of the shape as part of the at least one closed pore, and
summing all pixels that are part of the at least one closed pore to determine the closed pore porosity.

13. The method of claim 11, wherein determining the splat line porosity comprises executing a shape detection module, wherein executing the shape detection module comprises:
determining that an uninterrupted chain of adjacent pixels in the matrix of pixels all with a luminance value of zero that meets a threshold length is indicative of a splat line,
identifying at least one splat line in the image by finding the uninterrupted chain that meets the threshold length within the matrix of pixels,
determining an actual length of the identified splat line of the identified splat line by grouping all pixels of the matrix of pixels that have a luminance value of zero and are part of the uninterrupted chain of adjacent pixels as part of the at least one splat line, and
summing all pixels that are part of the at least one splat line to determine the splat line porosity.

14. The method of claim 13, wherein identifying the at least one splat line comprises determining that each pixel that is part of the at least one splat line is sandwiched between pixels that do not have a luminance value of zero.

15. The method of claim 11, wherein the closed pore porosity is determined at least partially by converting the oxide-filtered image into a first binary image; and
wherein the splat line porosity is determined at least partially by converting the raw image into a second binary image.

16. The method of claim 1, further comprising comparing the determined porosity to a predetermined target range, and
responsive to determining that the determined porosity does not fall within the predetermined target range, controlling, by the computing device, at least one parameter of a thermal spray gun configured to apply the thermally-sprayed coating.

17. A non-transitory computer-readable storage medium having stored thereon instructions that, when executed, configure a processor to:
receive a raw image indicative of a cross-section of a thermally-sprayed layer, wherein the raw image comprises a matrix of pixels, each pixel in the matrix of pixels defining a respective luminance value of a plurality of luminance values;
determine, based on the plurality of luminance values, at least one pixel of the matrix of pixels that corresponds to an oxide component in the layer;
remove the at least one pixel that corresponds to the oxide component in the layer from the matrix of pixels to generate a modified matrix of pixels;
generate, based on the modified matrix of pixels, an oxide-filtered image;
convert, based on the luminance values of the oxide-filtered image, the oxide-filtered image into a binary image; and
determine, based at least partially on the binary image, a porosity of the thermally-sprayed layer.

18. The non-transitory computer readable storage medium of claim 17, wherein, to determine the one or more pixels that correspond to the oxide component, the instruction further configure the processor to perform a local thresholding operation which comprises:
plotting each pixel of the matrix of pixels according to a respective luminance value of the pixel,
determining a local peak frequency of pixels with a particular luminance value occurring at a first luminance value,
determining a threshold matching range of luminance values surrounding the first luminance value,
setting the luminance value of pixels with a luminance value within the threshold matching range to the first luminance value, and
determining that the plurality of pixels with the first luminance value correspond to the oxide component in the coating layer.

19. The non-transitory computer readable storage medium of claim 17, wherein the local peak frequency of pixels is a first local peak frequency, and local thresholding further comprises determining a second local peak frequency and a third local peak frequency,
wherein the second local peak frequency is indicative of void volumes within the coating layer and the third local peak frequency is indicative of metal or alloy components within the coating layer.

20. A system comprising:
a thermal spray gun configured to apply a thermally-sprayed layer to a substrate;
an imaging device configured to capture an image indicative of a cross-section of the thermally spraying layer, wherein the image comprises a matrix of pixels, each pixel in the matrix of pixels defining a luminance value; and
a computing device configured to:
receive a raw image indicative of a cross-section of a thermally-sprayed layer, wherein the raw image comprises a matrix of pixels, each pixel in the matrix of pixels defining a respective luminance value of a plurality of luminance values;
determine, based on the plurality of luminance values, at least one pixel of the matrix of pixels that corresponds to an oxide component in the layer;
remove the at least one pixel that corresponds to the oxide component in the layer from the matrix of pixels to generate a modified matrix of pixels;
generate by the computing device and based on the modified matrix of pixels, an oxide-filtered image;
convert by the computing device and based on the luminance values of the oxide-filtered image, the oxide-filtered image into a binary image; and
determine, based at least partially on the binary image, a porosity of the thermally-sprayed layer.
